(19) United States
(12) Patent Application Publication
(10) Pub. No.: US 2026/0202936 A1
(43) Pub. Date: Jul. 16, 2026

(54) A PANEL ASSEMBLY

(71) Applicant: Flatfrog Laboratories AB, Lund (SE)

(72) Inventors: Aleksander Kocovski, Malmö (SE); Ola Wassvik, Lammhult (SE)

(21) Appl. No.: 19/136,235

(22) PCT Filed: Dec. 12, 2023
(86) PCT No.: PCT/SE2023/051245

§ 371 Date: Jun. 5, 2025

(30) Foreign Application Priority Data
Dec. 13, 2022 (SE) 22304125

(51) Int. Cl. G06F 3/042

(52) U.S. Cl. CPC G06F 3/042

(57) ABSTRACT

A panel assembly to be mounted on a surface for displaying user output and/or receiving user input is disclosed, comprising a transparent panel defining a front surface towards the user and an opposite rear surface, a display unit arranged at the rear surface, a retention assembly arranged at a periphery of the panel, wherein the panel is load bearing and configured to support the weight of the panel assembly when mounted to said surface, whereby a retention force (F) acting on the retention assembly to support the weight of the panel assembly, when mounted, is transferred to the panel via the retention assembly.

### TECHNICAL FIELD

The present invention relates generally to the field of panels for displays and/or for user interaction, such as touch panels. More particularly, the present invention relates to a panel assembly to be mounted on a surface for displaying user output and/or receiving user input.

### BACKGROUND ART

Known touch sensing apparatuses comprise a touch panel with a touch surface which is mounted to a display device. The display device and the touch panel are typically fixed to a back plate which is rigid and holds the display device and the touch panel in place. The back plate is made from steel or another stiff material and is mounted to a mounting surface such as a wall. A problem with known touch sensing apparatuses, in particular as the display size increases, is thus that they are very heavy and bulky. Handling becomes difficult such as when the apparatus is to be installed on a wall, and the installation becomes time consuming and cumbersome. The applications are thus typically limited to fixed installations, and re-positioning of the apparatus is difficult. Moreover, the manufacturing of such touch sensing apparatuses is complex with strict tolerances which holds back a more widespread use of large touch sensing apparatuses.

### SUMMARY

An objective is to at least partly overcome one or more of the above identified limitations of the prior art.

One objective is to provide a panel assembly to be mounted on a surface for displaying user output and/or receiving user input which is less complex to manufacture while being more compact, lighter and easier to handle. One objective is to provide a touch-sensing apparatus with such panel assembly.

One or more of these objectives, and other objectives that may appear from the description below, are at least partly achieved by means of a panel assembly and touch sensing apparatus according to the independent claims, embodiments thereof being defined by the dependent claims.

According to a first aspect a panel assembly to be mounted on a surface for displaying user output and/or receiving user input is provided, comprising a transparent panel defining a front surface towards the user and an opposite rear surface, a display unit arranged at the rear surface, a retention assembly arranged at a periphery of the panel, wherein the panel is load bearing and configured to support the weight of the panel assembly when mounted to said surface, whereby a retention force (F) acting on the retention assembly to support the weight of the panel assembly, when mounted, is transferred to the panel via the retention assembly.

Further examples of the invention are defined in the dependent claims, wherein features for the first aspect may be implemented for the second aspect, and vice versa.

Some examples of the disclosure provide for a compact panel assembly for a touch sensing apparatus.

Some examples of the disclosure provide for a compact panel assembly for a display such as a monitor or a tv.

Some examples of the disclosure provide for a panel assembly for a touch sensing apparatus which is less complex to manufacture.

Some examples of the disclosure provide for a panel assembly for a touch sensing apparatus which is less expensive to manufacture.

Some examples of the disclosure provide for a panel assembly for a touch sensing apparatus which is easier to handle.

Some examples of the disclosure provide for a panel assembly for a touch sensing apparatus which is easier to install and re-position.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the invention are capable of will be apparent and elucidated from the following description of examples of the present invention, reference being made to the accompanying drawings, in which;

FIG. 1 is a schematic illustration of a panel assembly, in a cross-sectional view, according to one example;

FIG. 2 is a schematic illustration of a panel assembly, in a cross-sectional view, according to one example;

FIG. 3 is a schematic illustration of a detail of a panel assembly for a touch sensing apparatus, in a cross-sectional view, according to one example;

FIG. 4 is a schematic illustration of a detail of a panel assembly for a touch sensing apparatus, in a cross-sectional view, according to one example;

FIG. 5 is a schematic illustration of a detail of a panel assembly for a touch sensing apparatus, in a cross-sectional view, according to one example;

FIGS. 6a-d are schematic illustrations a panel assembly, in perspective views, according to examples of the disclosure;

FIGS. 7a-c are schematic illustrations of a panel assembly, in cross-sectional views, according to examples of the disclosure;

FIGS. 8a-c are schematic illustrations of a panel assembly, in cross-sectional views, according to examples of the disclosure;

FIG. 9 is a schematic illustration of a detail of a panel assembly for a touch sensing apparatus, in a cross-sectional view, according to one example;

FIGS. 10a-b are schematic illustrations a panel assembly, in perspective views, according to examples of the disclosure;

FIGS. 11a-b are schematic illustrations a panel assembly, in perspective views, according to examples of the disclosure; and

FIGS. 12a-b are schematic illustrations of a panel assembly for a touch sensing apparatus, in cross-sectional views, according to examples of the disclosure.

### DETAILED DESCRIPTION OF EXAMPLE EMBODIMENTS

In the following, embodiments of the present invention will be presented for a specific example of a touch-sensitive apparatus. Throughout the description, the same reference numerals are used to identify corresponding elements.

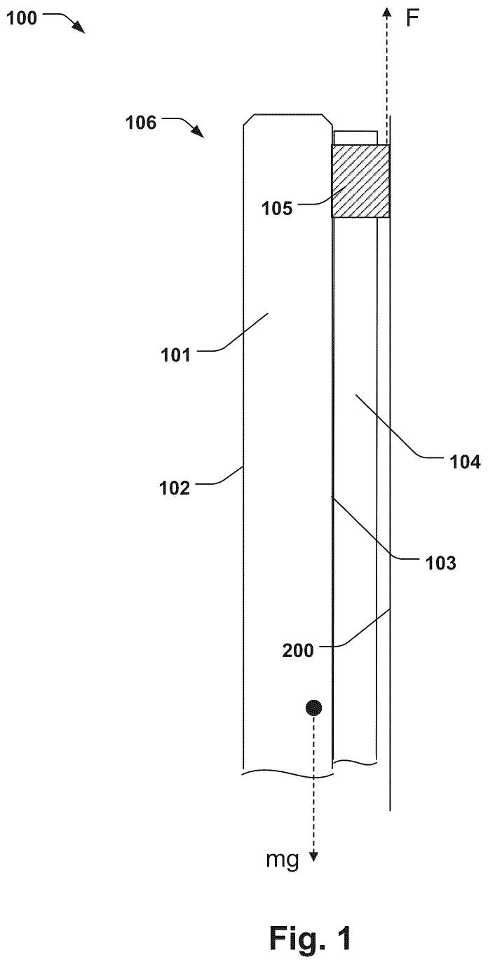

FIG. 1 is a schematic illustration of a panel assembly 100 for displaying user output and/or receiving user input. The panel assembly 100 may thus be utilized as a monitor, tv, touch display, electronic whiteboard, or any type of display or user interaction surface. The panel assembly 100 is configured to be mounted on a surface 200, such as a wall, as exemplified in FIG. 1. The example in FIG. 1 shows a vertical surface 200 but it is conceivable that the panel assembly 100 may be mounted to surfaces 200 being tilted at varying angles relative to a user or the direction of gravity. The panel assembly 100 comprises a transparent panel 101 defining a front surface 102 towards a user and an opposite rear surface 103. The panel 101 may be made of any solid material (or combination of materials) such as glass, poly(methyl-methacrylate) (PMMA) and polycarbonates (PC). The panel assembly 100 comprises a display unit 104 arranged at the rear surface 103 of the panel 101. The display unit 104 may comprise an LED LCD or OLED display. The panel 101 is thus configured to be overlaid on or otherwise integrated with the display unit 104. The panel assembly 100 comprises a retention assembly 105, 105a, arranged at a periphery 106 of the panel 101. The panel 101 is load bearing for the panel assembly 100 and thus configured to support the weight of the panel assembly 100 when mounted to a surface 200. A retention force (F) acting on the retention assembly 105 to support the weight of the panel assembly 100, when mounted, is consequently transferred to the panel 101 via the retention assembly 105, 105a. The panel 101 being load bearing for the panel assembly 100 should also be construed as the panel 101 being the main mechanical support of the panel assembly 100 to which the remaining components of the panel assembly 100 are anchored in fixed positions relative to each other and to the panel 101, while the panel 101 maintains its defined shape. The panel 101 maintains its shape and supports the weight of e.g. the display unit 104 when the panel assembly 200 is mounted to a surface 200 such as a wall. For example the panel assembly 100 may be mounted at top right and left corners 112a, 112b, with retention assemblies 105, without warping or shape distortion of the panel 101, or without significant shape distortion of the panel 101 beyond a defined threshold value. For example the shape distortion such as a change in geometrical proportions beyond an initially defined reference configuration, when the panel assembly 100 and panel 101 are placed in an unloaded state, may be less than 2% of the dimensions of such reference configuration. If the panel 101 would be removed, the structural integrity of the panel assembly 100 cannot be maintained, and it would warp or distort its shape, or collapse.

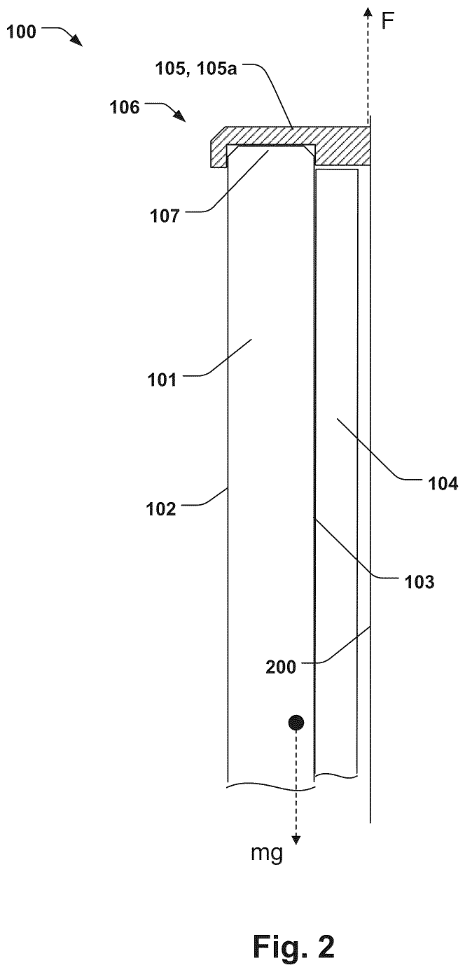

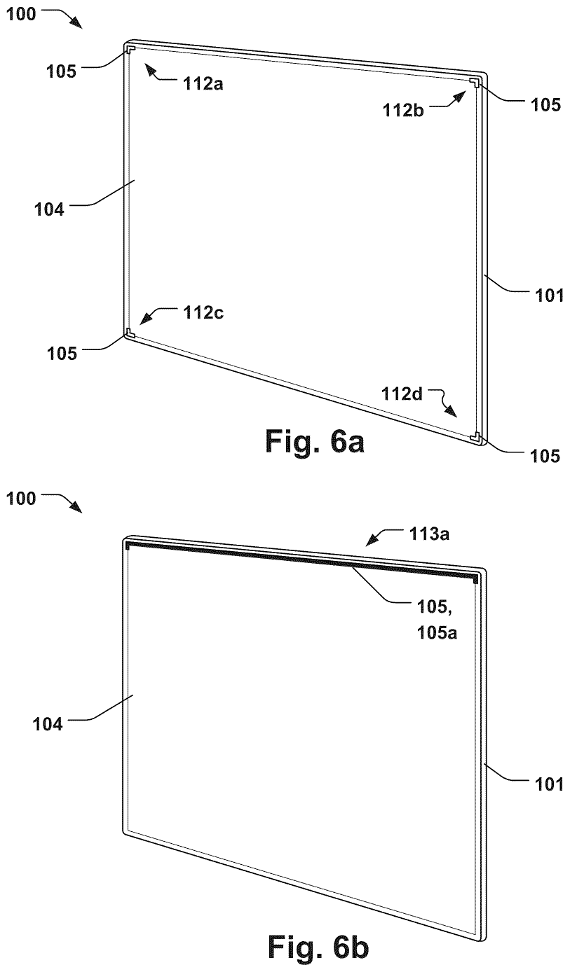

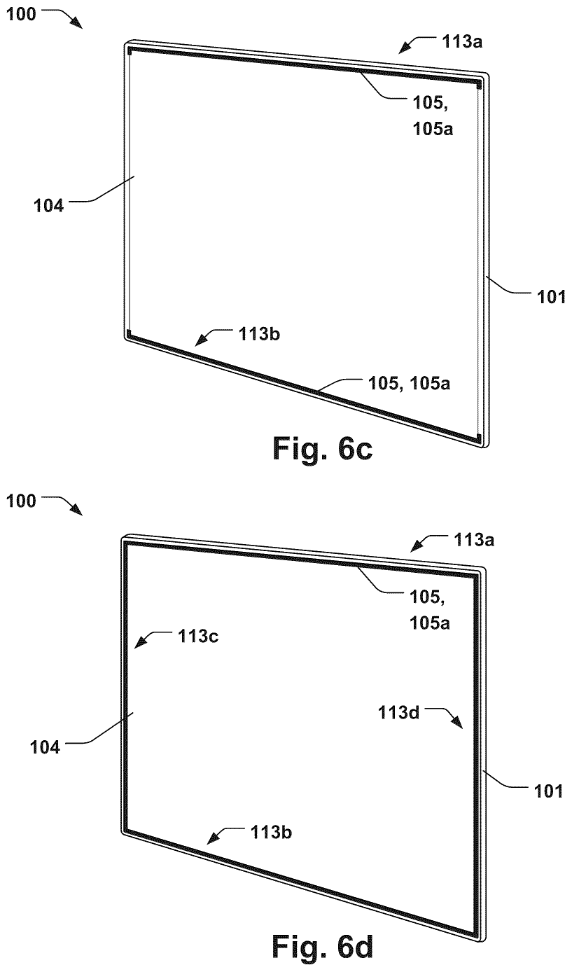

FIG. 1 shows an example where the display unit 104 is arranged over the rear surface 103 of the panel 101 and a retention assembly 105 is arranged at the periphery 106 and fixed to the rear surface 103. The retention assembly 105 is attached to a surface 200 and supports the weight of the panel assembly 100. A retention force (F) thus acts on the retention assembly 105, indicated in FIG. 1 with a dashed arrow at the interface between the retention assembly 105 and the surface 200. The retention force (F) is essentially F=mg in this example, where m is the mass of the panel assembly 100 and g is the gravitational constant. The retention assembly 105 is anchored to the rear surface 103 of the panel 101 and the retention force (F) is accordingly transferred to the panel 101 and acting on the panel 101 at the interface between the retention assembly 105 and the panel 101. The panel 101 has a stiffness which allows the retention force (F) to be transferred to the panel 101 via the retention assembly 105 while maintaining its shape, i.e. without being deformed. FIG. 2 shows another example where the retention assembly 105 is anchored to edges 107 of the panel 101 so that the retention force (F) can be transferred to the panel 101 via said edges 107. The retention assembly 105, 105a, may be arranged along any of the sides 113a-d of the panel 101, as described further below with reference to FIGS. 6a-d and 10a-b.

The panel 101 is configured to support the weight of the panel assembly 100, which at least comprises the display unit 104. Hence, the display unit 104 may be attached to the rear surface 103 of the panel 101, without any attachment to the mounting surface 200. I.e. as the panel 101 is load bearing for the weight of the panel assembly 100 the need to include further support structures can be dispensed with, which allows for a more compact and lighter panel assembly 100. A touch sensing apparatus 300 comprising the panel assembly 100 is thus less cumbersome to handle and easier to install and reposition as desired. Previous panel assemblies are more complex and bulky, since they typically incorporate a rigid back support structure covering the rear of the panel assembly, to support the front glass panel and the rear display unit, and to fix their relative positions to each other. The glass panel will in such case have no load bearing function for any of the other components such as the rear display. Having a panel 101 which is load bearing of the whole panel assembly 100 allows for reducing the number of components and manufacturing tolerances are easier to fulfill, since less components need to be accurately positioned relative to each other. In particular, the panel 101 may in some examples have a touch surface and be configured to be utilized in a touch sensing apparatus 300, when the panel assembly 100 comprises a touch sensor 118. The panel 101 is rigid to allow a consistent detection of touch events when the user press on the touch surface, and the mechanical integrity of such panel 101 for touch detection can conveniently be utilized to mechanically support the panel assembly 100, and touch sensing apparatus 300, as the main load bearing component thereof. Any of the panel assemblies 100 in FIGS. 1-12 may comprise a touch sensor 118, and a plurality of light emitters 119 and detectors 120 arranged along the periphery 106 of the panel 101, to provide a touch sensing apparatus 300.

The retention assembly 105 may comprise a frame 105a arranged around edges 107 of the panel 101 to fix the position of the panel 101 in relation to the frame 105a, whereby the aforementioned retention force (F) is transferred to the panel 101 via the frame 105a. FIGS. 2, 4, 7a-c, 11a-b, 12a-b, show examples of a frame 105a arranged around the edges 107 of the panel 101. The frame 105a is configured to transfer the retention force (F) to the panel 101 so that the panel 101 is load bearing for the panel assembly 100 as described above.

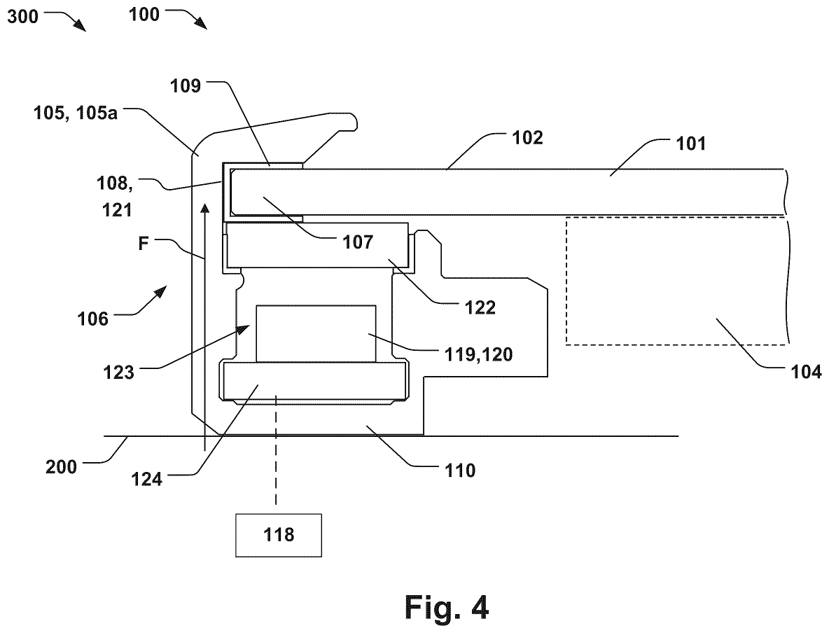

The frame 105a may comprise a receiving portion 108 in which the edges 107 are received. A retention element 109 may be arranged in the receiving portion 108 between the panel 101 and the frame 105a to exert a force onto the panel edges 107 to anchor the panel 101 to the frame 105a. FIG. 4 shows an example of a touch sensing apparatus 300 comprising the panel assembly 100, where edges 107 of the panel 101 are arranged in receiving portion 108 and in abutment with retention element 109. The retention element 109 may comprise an adhesive element or other retention element configured to transfer a force between the frame 105a and the panel 101. The receiving portion 108 may form a slot 121 in which the retention element 109 is arranged and in which the edges 107 are received. The slot 121 may be formed in the frame 105a and/or in conjunction with a further support element 122 as schematically illustrated in FIG. 4. The support element 122 is in this case light transmissive for light emitted from emitter 119, so that the emitted light can propagate through the panel 101 and be reflected towards the front surface 102 which is a touch surface in this example. The frame 105a may comprise a cavity 123 in which the emitters 119 and detectors 120 are arranged as exemplified in FIG. 4. The emitters 119 and detectors 120 are mounted to a substrate 124 which may be fixed in position in the cavity 123. The frame 105a may thus allow the transfer of the retention force (F) to the panel 101 (as schematically indicated with arrow F in FIG. 4) as well as support and fix the emitters 119 and detectors 120 into place relative to the panel 101. FIG. 4 shows a schematic position of a display unit 104 arranged at the rear surface 103. The display unit 104 may be directly attached to the panel 101m e.g. with an adhesive, and/or supported by the frame 105a.

The frame 105a may comprise a support 110 configured to be arranged against a surface 200, e.g a wall. The support 110 is configured to be mounted to the surface 200 for the mounting of the panel assembly 100.

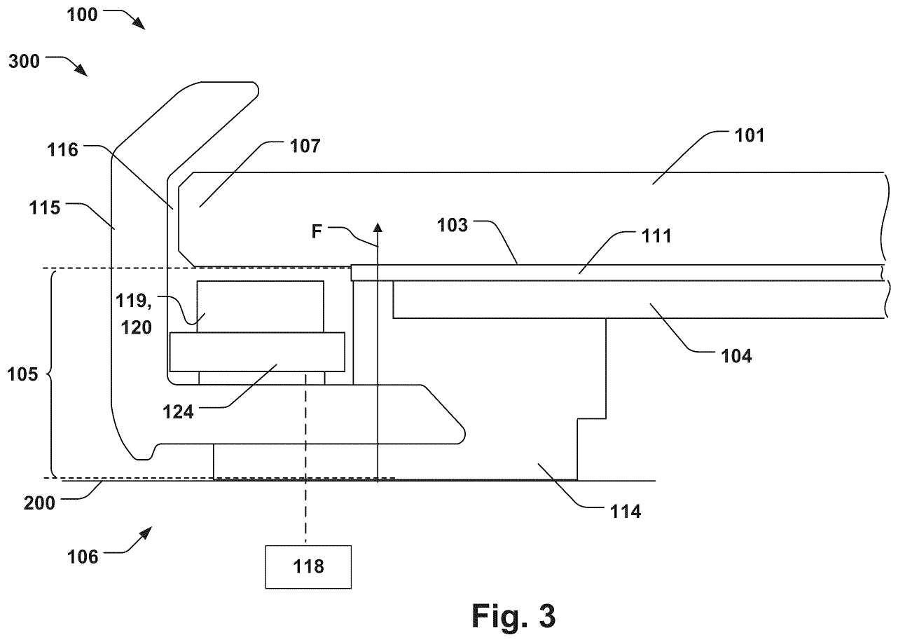

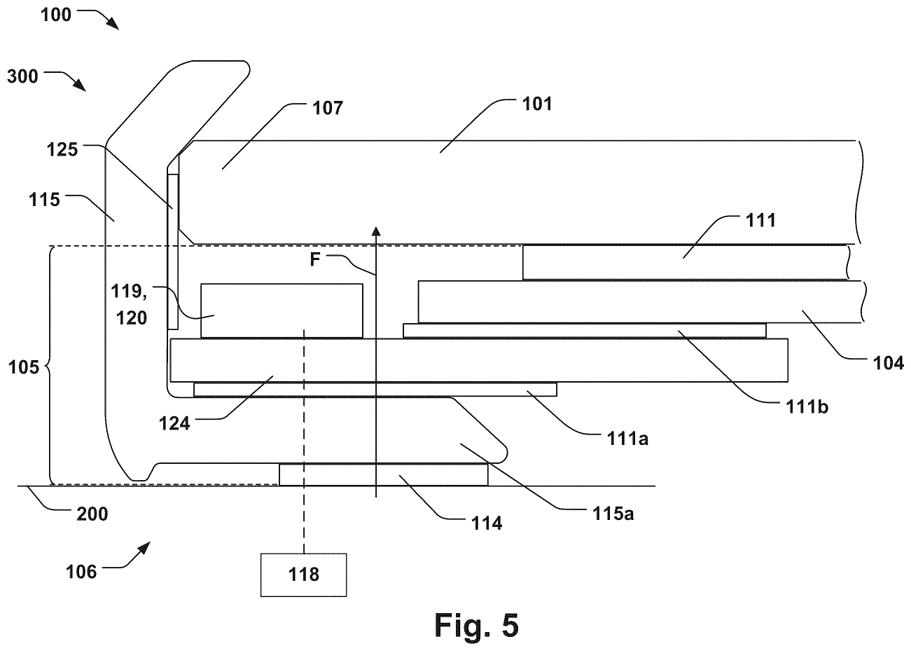

The retention assembly 105 may be fixed to the rear surface 103 of the panel 101, as schematically illustrated in the examples of FIGS. 1, 3, 5, 8a-c, 9, and 10a-b. The retention assembly 105 may thus transfer the retention force (F) to the rear of the panel 101 without necessarily having to exert a retention force on the edges 107 of the panel 101. FIG. 3 shows an example of a retention assembly 105 which is bonded to the rear surface 103 with an adhesive layer 111. FIG. 5 is another schematic illustration of a retention assembly 105 which is attached to the panel 101 via an adhesive layer. In either case the retention force (F) may be transferred to the panel 101 via the retention assembly 105 when the panel assembly 100 is mounted to a surface 200 (as schematically indicated with arrow F in FIGS. 3 and 5). The retention assembly 105 may comprise further intermediate adhesive layers 111a, 111b, to form a stacked configuration as exemplified in FIG. 5. The retention assembly 105 may comprise a base 114 configured to be mounted to a surface 200. The panel assembly 100 may comprise an edge cover 115 being arranged around edges 107 of the panel 101. The edge cover 115 may comprise an edge cover support 115a which extends to the rear of the panel assembly 100 for attachment of the edge cover 115. The stacked configuration in FIG. 5 comprises a base 114 of the retention assembly 105, an edge cover support 115a, a substrate 124 to which the emitters 119 and detectors 120 are connected, and a display unit 104, such as an OLED display. The substrate 124 may thus be part of the retention assembly 105 in one example. A gasket 125 may be provided between the edges 107 and the edge cover 115. In FIG. 5 the display unit 104 may be attached to the panel 101 via the adhesive layer 111, as in the example in FIG. 3, while the edge cover support 115a and the substrate 124 may be attached via intermediate adhesive layers 111a, 111b. The edge cover support 115a may be a continuous integral part of the edge cover 115 extending around edges 107. The edge cover support 115a may however be a separate part to which the edge cover 115 is attached in some examples. The edge cover 115, or an edge cover support 115a thereof, the may be coupled to or integrated with the retention assembly 105 to have a fixed position in relation to the panel 101.

It should also be understood that other stacked configurations are conceivable. In one example the base 114 is attached directly to adhesive layer 111 at the rear surface 103, as schematically shown in FIG. 3. An edge cover 115, or an edge cover support 115a thereof, may be attached to the base 114 of the retention assembly 105 by various methods, such as by clamps, pins, screws, adhesives etc. The substrate 124 may be attached to the base 114 or to the edge cover 115. In some examples the edge cover 115, or an edge cover support 115a thereof, may be attached to base 114 and/or the substrate 124 without necessarily be a supporting part for the transfer of the retention force (F) to the rear surface 103 of the panel 101, in which case the retention force (F) is transferred from the base 114 directly to the panel 101. For example, the edge cover 115 may be separated from the edges 107 of the panel 101 with a spacing 116, as schematically shown in FIG. 3. Regardless, the edge cover 115 is configured to primarily protect components such as the emitters 119 and detectors 120, which is otherwise accomplished by the frame 105a in the examples in FIGS. 2, 4, 7a-c, 11a-b, 12a-b. The frame 105a in the aforementioned examples is however configured to anchor to the edges 107 of the panel 101 to transfer the retention force (F) to the panel 101, while the retention assembly 105 in FIGS. 1, 3, 5, 8a-c, 9, and 10a-b is configured to transfer the retention force (F) to the rear surface 103 of the panel 101, e.g. via adhesive layer 111. It is conceivable that the edge cover 115 may be omitted in some examples. E.g. the panel assembly 100 may provide for a display such as a monitor or tv where the display unit 104 and the base 114 are bonded to the rear surface 103 with an adhesive layer 111 while having no elements extending radially beyond the edges 107 of the panel 101, for providing a borderless display.

The panel assembly 100 may comprise a plurality of said retention assemblies 105 arranged at corners 112a-d of the panel 101. FIG. 6a shows an example where the panel assembly 100 comprises a retention assembly 105 at each corner 112a-d. The panel assembly 100 may thus be anchored to a surface 200 at each of the corners 112a-d and the retention assemblies 105 transfer the retention force (F) which supports the weight of the panel assembly 100 to the panel 101. A touch sensing apparatus 300 may be provided comprising a panel assembly 100 as exemplified in any of FIGS. 6a-d. The panel 101 is thus load bearing and supports the weight of such touch sensing apparatus 300. It is conceivable that the retention assemblies 105 as exemplified in any of FIGS. 6a-d may be attached to the rear surface 103 of the panel 101, or extend around the edges 107 of the panel 101 to anchor the edges 107 in a receiving portion 108, as described in examples above.

The retention assembly 105 may extend along at least one side 113a-d of the panel 101. FIG. 6b is a schematic illustration of a retention assembly 105 being arranged along an upper horizontal side 113a, while FIG. 6c is an example of a retention assembly 105 being arranged along both upper and lower horizontal sides 113a, 113b, providing for an efficient transfer of the retention force (F) to the panel 101 for supporting the weight of the panel assembly 100/touch sensing apparatus 300. FIG. 6d shows an example of the retention assembly 105 extending around the periphery 106 of the panel 101 to further increase the area over which the retention force (F) may be transferred to the panel 101, thus reducing the pressure on the panel 101.

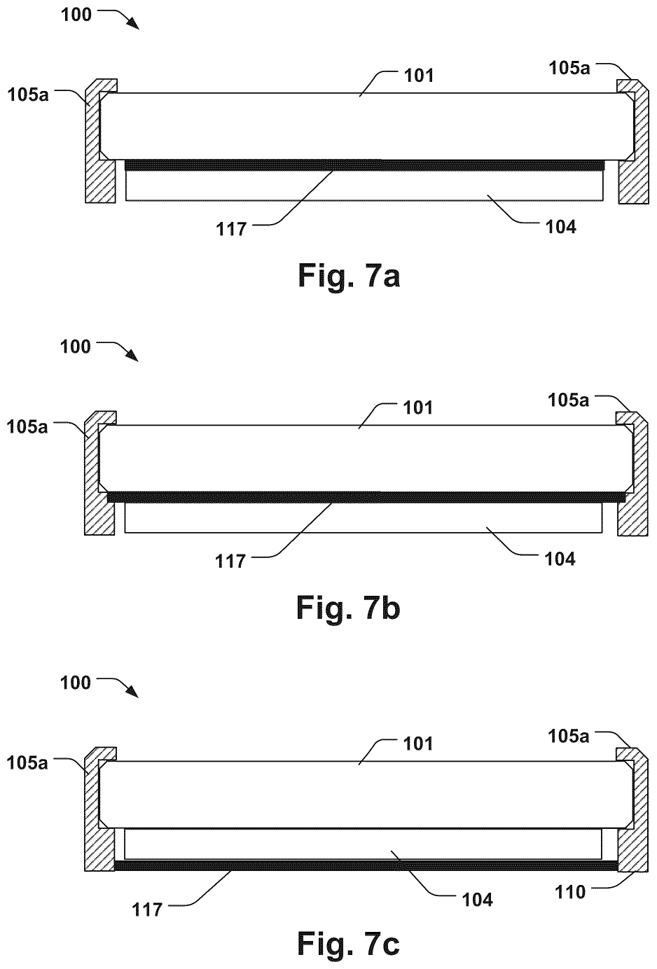

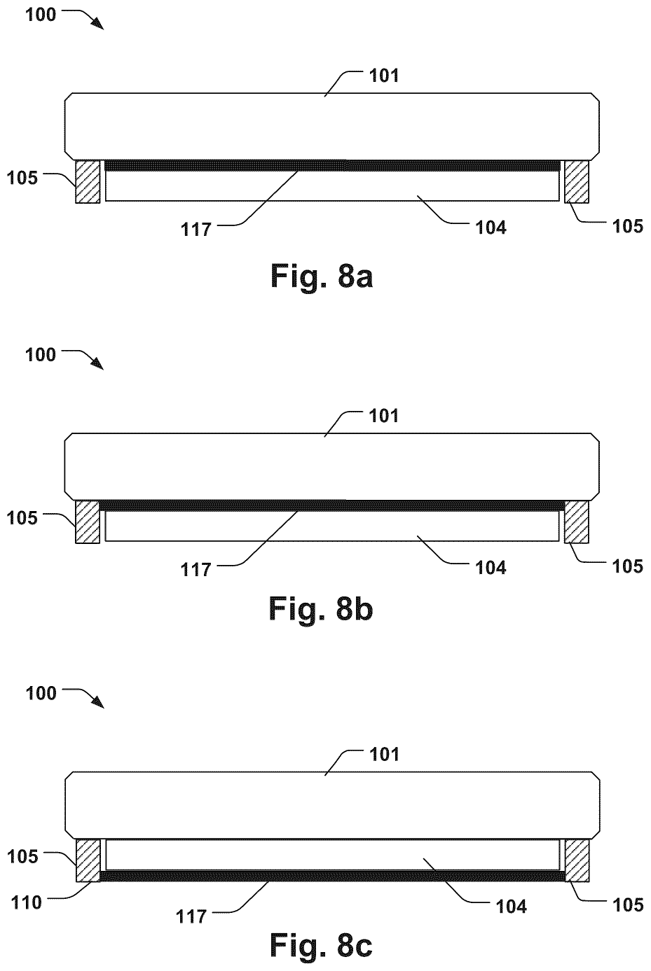

The panel assembly 100 may comprise an intermediate support structure 117 being arranged to extend across at least part of the rear surface 103. FIGS. 7a-c show schematic examples of a support structure 117 for a panel assembly 100 where the retention assembly 105 comprises a frame 105a as described above. FIGS. 8a-c show schematic examples of an intermediate support structure 117 for a panel assembly 100 where the retention assembly 105 is fixed to the rear surface 103 of the panel 101. The intermediate support structure 117 is referred to as support structure 117 in the following for brevity.

The support structure 117 provides for a further increase in the mechanical integrity of the panel assembly 100, e.g. by increasing the stiffness of the overall panel assembly 100. The support structure 117 may comprise a polymer, metal, glass or any combination thereof. The support structure 117 may comprise a layer and/or a sheet of material, and/or a mesh, and/or any elongated structure such as structs, ribs, cross-bars etc. The support structure 117 may comprise a laminate structure comprising a plurality of layers, such as a plurality of polymer, glass, and/or metal layers, or any combination thereof. The support structure 117 may be attached to the panel assembly 100 by adhesives, bolts, pins, clamps, screws etc, or any other fixation mechanism. FIGS. 7a and 8a show examples where the support structure 117 is arranged between the rear surface 103 and the display unit 104. The support structure 117 may in such case be attached to the rear surface 103, e.g. by an adhesive layer. Alternatively, or in addition the support structure 117 may be attached to the display unit 104 and/or to the retention assembly 105, 105a, see FIGS. 7b and 8b. The support structure 117 is light transmissive when arranged between the rear surface 103 and the display unit 104.

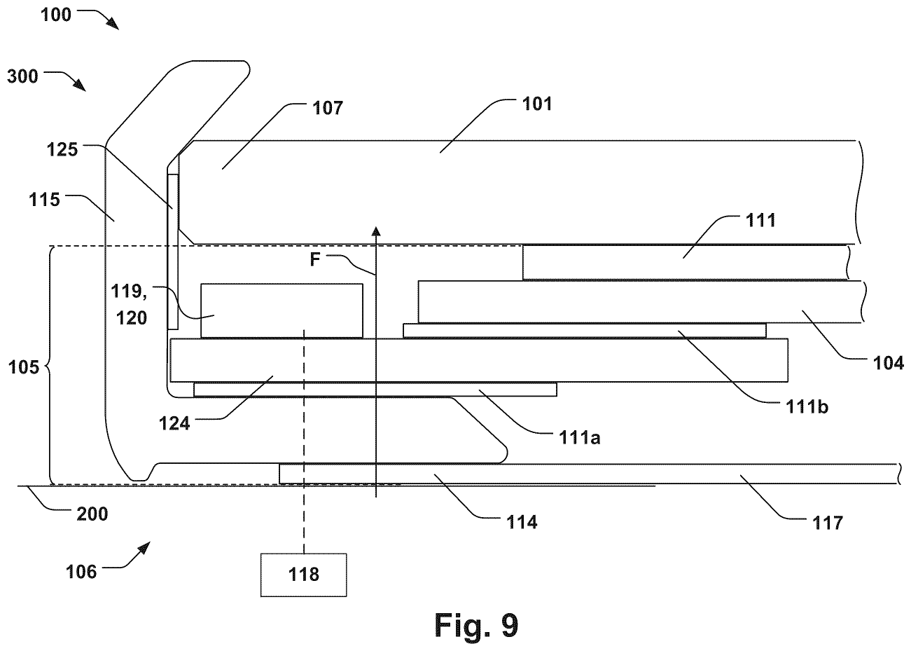

FIGS. 7c and 8c show examples where the support structure 117 is arranged at the rear of the display unit 104 and attached to the retention assembly 105, 105a. The support structure 117 may thus be fixed to the base 114 or the support 110 of the frame 105a. FIG. 9 shows an example where the support structure 117 is integrated with the base 114, e.g. as a single monolithic piece.

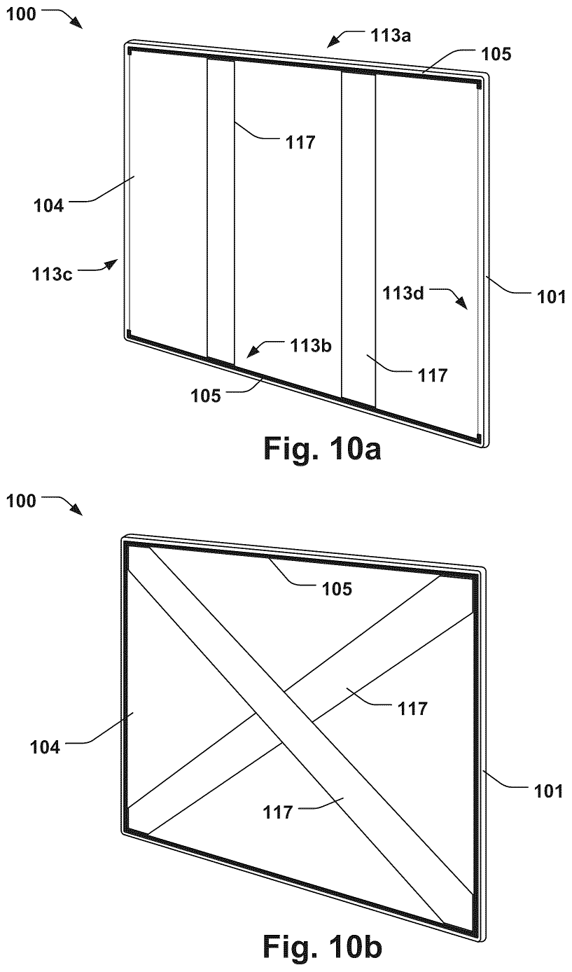

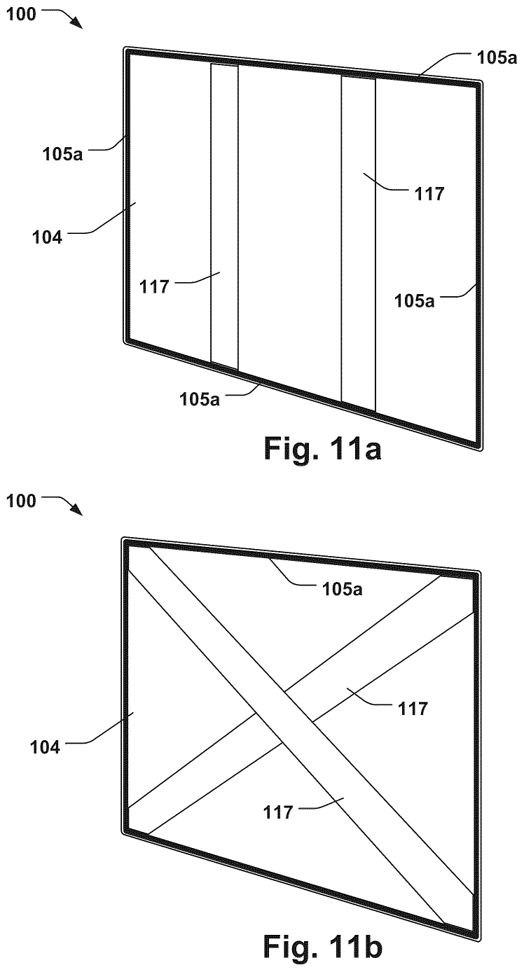

FIGS. 10a-b and 11a-b show examples of the support structure 117 being attached to the retention assembly 105, 105a. The support structure 117 may thus extend between opposite sides 113a-c of the panel assembly 100. FIGS. 10a-b show examples of a retention assembly 105 being attached to the rear surface 103 of the panel 101. FIG. 10a is a schematic illustration of a support structure 117 extending between upper and lower horizontal sides 113a-b. The support structure 117 is arranged as two elongated ribs in this example, whereas FIG. 10b shows a support structure 117 arranged in a crossed configuration and a retention assembly 105 surrounding the periphery 106 of the panel 10. It is conceivable however that the support structure 117 may comprise a plurality of different configurations. FIGS. 11a-b show corresponding examples where the retention assembly comprises a frame 105a as described above.

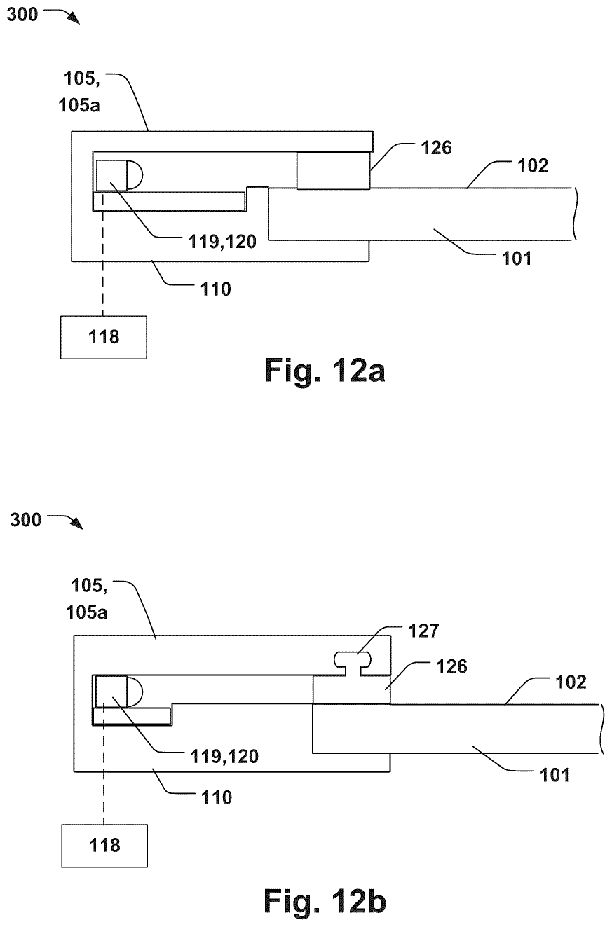

A touch sensing apparatus 300 is provided comprising a panel assembly 100 as described above. The touch sensing apparatus 300 comprises a touch sensor 118 and a plurality of light emitters 119 and detectors 120 arranged along the periphery 106 of the panel 101. The front surface 102 is in this case a touch surface. The light emitters 119 are arranged to emit a respective beam of emitted light above the touch surface 102, and the light detectors 120 are arranged to receive detection light from the emitted light, whereby the touch sensor 118 is configured to detect a touch event on the touch surface 102 based on the detection light. FIGS. 3, 4, 5, 9, and 12a-b show examples of light emitters 119 and detectors 120 arranged along the periphery 106 of the panel 101. The emitters 119 and detectors 120 are arranged below the panel 101 in FIGS. 3, 4, 5, 9, and above the panel 101 in FIGS. 12a-b, with respect to a normal axis of the plane in which the panel 101 extends. The light may be emitted through the panel 101 in the panel assembly 100 and touch sensing apparatus 300 as exemplified in FIGS. 3, 4, 5, 9, while the light may be emitted through a light transmissive element 126 arranged above the touch surface 102 of the panel 101 in the examples of FIGS. 12a-b. The light transmissive element 126 may be arranged between the frame 105a of the retention assembly 105 and the panel 101. The light transmissive element 126 may be attached by an adhesive or any other retention structure, such as by an interlocking portion 127 which anchors to the frame 105a, as exemplified in FIG. 12b. The panel 101 is load bearing for the touch sensing apparatus 300, and supports the weight of the touch sensing apparatus 300, e.g. when being mounted to a surface 200, as described above with reference to the panel assembly 100. Hence, a touch sensing apparatus 300 is provided which is more compact, easier to handle, and less complex to manufacture.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims. For example, the specific arrangement of emitters and detectors as illustrated and discussed in the foregoing is merely given as an example.

1. A panel assembly to be mounted on a surface for displaying user output and/or receiving user input, comprising;
a transparent panel defining a front surface towards the user and an opposite rear surface,
a display unit arranged at the rear surface, and
a retention assembly arranged at a periphery of the panel,
wherein the panel is load bearing and configured to support the weight of the panel assembly when mounted to said surface,
whereby a retention force acting on the retention assembly to support the weight of the panel assembly, when mounted, is transferred to the panel via the retention assembly.

2. Panel assembly according to claim 1, wherein the retention assembly comprises a frame arranged around edges of the panel to fix the position of the panel in relation to the frame, whereby said retention force is transferred to the panel via the frame.

3. Panel assembly according to claim 2, wherein the frame comprises a receiving portion in which the edges are received, wherein a retention element is arranged in the receiving portion between the panel and the frame to exert a force onto the panel edges to anchor the panel to the frame.

4. Panel assembly according to claim 2, wherein the frame comprises a support configured to be arranged against the surface and to be mounted to the surface for mounting of the panel assembly.

5. Panel assembly according to claim 1, wherein the retention assembly is fixed to the rear surface of the panel.

6. Panel assembly according to claim 5, wherein the retention assembly is bonded to the rear surface with an adhesive layer.

7. Panel assembly according to claim 5, wherein the retention assembly comprises a base configured to be arranged against the surface and to be mounted to the surface for mounting of the panel assembly.

8. Panel assembly according to claim 5, comprising an edge cover being arranged around edges of the panel.

9. Panel assembly according to claim 8, wherein the edge cover is separated from the edges of the panel with a spacing.

10. Panel assembly according to claim 8, wherein the edge cover is coupled to or integrated with the retention assembly.

11. Panel assembly according to claim 1, comprising a plurality of said retention assemblies arranged at corners of the panel.

12. Panel assembly according to claim 1, wherein the retention assembly extends along at least one side of the panel.

13. Panel assembly according to claim 12, wherein the retention assembly extends around the periphery of the panel.

14. Panel assembly according to claim 1, comprising an intermediate support structure being arranged to extend across at least part of the rear surface.

15. Panel assembly according to claim 14, wherein the intermediate support structure is fixed to the retention assembly.

16. Panel assembly according to claim 14, wherein the intermediate support structure is fixed to the rear surface of the panel.

17. Panel assembly according to claim 14, wherein the intermediate support structure is fixed to the display unit.

18. Panel assembly according to claim 14, wherein the intermediate support structure comprises a laminate structure.

19. Touch sensing apparatus comprising a panel assembly according to claim 1, a touch sensor and a plurality of light emitters and detectors arranged along the periphery of the panel, wherein the front surface is a touch surface, and wherein the light emitters are arranged to emit a respective beam of emitted light above the touch surface, and the light detectors are arranged to receive detection light from the emitted light, wherein the touch sensor is configured to detect a touch event on the touch surface based on the detection light.
